(19) United States
(12) Patent Application Publication
(10) Pub. No.: US 2009/0092086 A1
(43) Pub. Date: Apr. 9, 2009

(54) APPARATUS FOR TRANSMITTING DATA ON CONTENTION BASED RESOURCE IN RADIO COMMUNICATION SYSTEM AND METHOD THEREOF

(76) Inventors: Ju-Ho Lee, Gyeonggi-do (KR); Xiaoqiang Li, Beijing (CN); Yujian Zhang, Beijing (CN)

Correspondence Address: THE FARRELL LAW FIRM, P.C., 333 EARLE OVINGTON BOULEVARD, SUITE 701, UNIONDALE, NY, 11553, US

(21) Appl. No.: 12/160,138

(22) PCT Filed: Jan. 8, 2007
(86) PCT No.: PCT/KR2007/000106

§ 371 Date: Jul. 7, 2008

(30) Foreign Application Priority Data
Jan. 6, 2006 (CN) 2006100005299.5

(51) Int. Cl. H04W 72/08; H04W 72/04

(52) U.S. Cl. 370/329; 455/452.1; 455/452.2

(57) ABSTRACT

An apparatus and method for transmitting data on a contention based resource in a radio communication system. A base station broadcasts a definition of uplink contention based resource groups and a criterion for a User Equipment (UE) to use for selecting a group. The UE selects an uplink contention based resource to transmit data according to the criterion for selecting the group. The apparatus and method improve data transmission service quality of a UE in a border area of a cell may by providing an effective scheme, thereby improving uplink system capacity.

### PRIORITY

This application is an National Stage filing of PCT Application PCT/KR2007/000106, filed on Jan. 8, 2007 claims, which claims priority to an application filed in China on Jan. 6, 2006, assigned Serial No. 200610005299.5, the contents of which are incorporated herein by reference.

### BACKGROUND OF THE INVENTION

1. Field of the Invention

The present invention relates generally to a radio communication system, and particularly to an apparatus and method for transmitting data on contention based resource in a radio communication system.

2. Description of the Related Art

In a radio communication system, a channel from a Base Station (BS) to a User Equipment (UE) is usually called a downlink channel, and a channel from the UE to the BS is usually called an uplink channel. Both the downlink channel and the uplink channel signal will be subject to fading caused by the radio channel.

Radio channel fading generally includes three parts: path loss, shadow fading, and fast fading. Path loss is normally determined by a distance between the BS and the UE. Generally, the longer the distance is, the bigger the path loss is; the shorter the distance is, the smaller the path loss is. In addition, path loss is also related to the environment (e.g., macro cell/micro cell, urban/rural).

Shadow fading is caused by the positioning of a large object between the BS and the UE, e.g., a mountain, large architecture, etc. Path loss and shadow fading are generally slow over time. Generally, path loss and shadow fading are both collectively called path loss. Herein, path loss will also generally refer to both path loss and shadow fading.

Fast fading refers to fast change of radio channel due to movement of the UE or the movement of objects in a surrounding environment.

The UE can measure the radio channel fading of the downlink channel. Such measurement is generally executed on signals with transmission power already known. For example, if the BS generally broadcasts transmission power P_{TX} of downlink common pilot, the UE may calculate that the downlink radio channel fading is P_{TX}-P_{RX} by measuring receiving power P_{RX} of the downlink common pilot. The measuring result is the instantaneous downlink radio channel fading. If the UE averages the measuring result for the relatively longer time period, such as hundreds of milliseconds, the exact downlink path loss can be obtained.

Single Carrier Frequency Division Multiple Access (SC-FDMA) is a high spectrum efficient and low peak to average ratio radio multiple access technology. An implementation method of its frequency domain is illustrated in FIG. 5.

Referring to FIG. 5, modulation symbol 501 is converted into a frequency domain signal in a Fast Fourier Transform (FFT) 502 module, then subject to module 503 for specific mapping. In the sub-carrier mapping module 503, if the user data is mapped to consecutive sub-carriers, the transmission mode is called the localized transmission mode. If the user data is mapped to sub-carriers with an equivalent interval, it is called the distributed transmission mode. Usually, no overlapping is allowed for the sub-carriers for the UEs in the same cell. This resource allocation method is called orthogonal resource allocation in frequency domain. Another allocation method is that several UEs of the same cell use the same sub-carriers for transmitting, and this kind of resource allocation method is called contention based resource allocation in frequency domain.

Data, after sub-carrier mapping, is subject to Inverse Fast Fourier Transform (IFFT) in IFFT module 504 to be converted into a time domain. In a Cyclic Prefix (CP) insertion module 505 a CP of data is added to the data. There are two benefits for adding a CP: one is eliminating interference of sub-carriers in frequency domain due to asynchronization of various UEs and the other is that the introduction of CP enables the receivers to use a frequency domain equalization algorithm of high performance and low complexity. As the SC-FDMA uses the orthogonal resource allocation method to eliminate interference among cells, and as algorithm of equalization in frequency domain has improved its performance, the SC-FDMA has high spectrum efficiency.

Another characteristic of SC-FDMA is that it introduces FFT module 502. Peak to average ratio of a signal is relatively low, thus making the power amplifier of the UE more effective, thereby saving power. Another advantage of a low peak to average ratio is that a UE in a border area of the cell may enjoy higher data rate and thus the network coverage is enlarged.

In research of Long Term Evolution (LTE) by the 3^{rd} Generation Partnership Project (3GPP) standardization group, frame structure designed for SC-FDMA is illustrated in FIG. 6.

Referring to FIG. 6, a radio resource is fragmented into frames 601-603, where a frame duration is 10 ms. Each radio frame is divided into several sub-frames 604-607. More specifically, every frame contains 20 sub-frames, and the length of the sub-frame is 0.5 ms. Each sub-frame contains several SC-FDMA symbols. Among the SC-FDMA symbols, there are 6 relatively longer symbols 608, 610, 611, 612, 613, and 615, and 2 relatively shorter symbols 609 and 614. Short symbols are generally used to transmit a pilot.

Orthogonal resource allocation method in a time domain is that UEs in the same cell use different sub-frames or SC-FDMA symbols to transmit data. By combining the frequency-domain and time-domain resource allocation methods, the uplink resource may be allocated to users in the mode of the 2D grid of time-domain and frequency-domain in the SC-FDMA system. In this mode, the orthogonal resource allocation method ensures that resources used by UEs have no overlap either in time domain or frequency domain, thus for the receiving side in the BS, the interference source of some UE only comes from interference of neighboring cells and thermal noise. When several UEs transmit data in the same time domain and frequency domain in a competitive way, for the receiving side of the BS, the interference source of some UE comes from interference of neighboring cells and thermal noise, and also interference from the UEs that use the same contention based resource.

In the radio communication system, during the initial stage of data transmission, generally contention based resources are used. There are mainly two methods: one is that the UE uses random access when first accessing to the network and the other is that the UE has already accessed to the network and has a little data to transmit, it can use contention based resource to transmit.

Using random access means that when the UE has data to transmit or when the network pages the UE, the operation that the UE accesses to the network. Due to the uncertainty of the UE initiating random access, the network generally preserves some contention based resources for the UEs to access to the network. When the UE is using random access, it generally needs to transmit random access information. In addition, in some systems such as WCDMA, before transmitting random access information, the UE needs to transmit a preamble. The preamble enables the BS to make a judgment of timing and power for the UE during the random access process.

The second situation is that the UE has already accessed to the network. For some types of service, the UE is not always transmitting data. For example, when the UE is reading the web pages, there may be some reading time, thus no uplink data is requested. When the UE needs to transmit data, there are generally two methods. The first method is that the UE transmits scheduling request to the network, which includes data condition in UE buffer and transmitting power condition of the UE. In this way the network can decide how to schedule the UE according to scheduling request. The second method is that when the amount of data to be transmitted is small, the UE may transmit the data directly on the contention based resource.

In order to improve the Signal to Noise Ratio (SNR) of what the BS receives from the UE that uses orthogonal resource, flexible fractional frequency reuse is commonly utilized. An embodiment of flexible fractional frequency reuse is illustrated in FIG. 1.

Referring to FIG. 1, frequency resources of the system is divided into 4 parts. For a UE that is located in a central area of the cells, i.e., nearer to the BS, the same frequency band is allocated to transmit data. In FIG. 1, a UEs in the central areas of cells 101, 102, 103, 104, 105, 106, and 107 may use the same frequency band to transmit data. As the interference that the UE located in central area of the cells receives is relatively small, this scheme can ensure relatively high spectrum efficiency. The frequency reuse factor of this frequency allocation method is 1.

For a UE in a border area of the cells, the network allocates frequency bands according to groups. In FIG. 1, the UEs in a border area of cell 101 use the same frequency band, the UEs in cells 102, 104, and 106 use the same frequency band, and the UEs in cells 103, 105, and 107 use the same frequency band. The frequency reuse factor of frequency allocation method is 3.

Accordingly, for UEs in a border area of cell 101, interference from UEs in neighboring cells 102, 103, 104, 105, 106, and 107 will have no effect. Neighborhood cell interference for UEs in the border of cell 101 only comes from peripheral cells 102, 103, 104, 105, 106, and 107. As those cells are far away from cell 101, the interference is relatively small, thus the SNR of UE in border area of cell 101 is improved efficiently.

In the same way, SNR of UEs in border areas of cells 102, 103, 104, 105, 106, and 107 is also improved efficiently. This scheme makes available spectrum resource for every cell reduced.

For example, cell 101 cannot use a spectrum resource used by the UE in border area of cell 102 and 103. However as the SNR of UE in border area of the cell is improved, the throughput of the UE in the border area of the cell is also improved, which increases the effectiveness that the system service covers the border of the cell. If a frequency band resource is divided reasonably, the throughput of the whole cell can be improved. However, it is noted that this scheme is only applicable in data transmission through the orthogonal resource, namely, where the BS explicitly schedules the data transmission of the UE.

For transmission on the contention based resource, the existing transmission scheme does not consider difference of downlink channel quality of the UEs when allocating time domain and frequency domain resource. The disadvantage of the method is that for UE in the border area of the cell, as the path loss is relatively larger, the SNR is relatively lower, thus transmission quality is not ensured.

### SUMMARY OF THE INVENTION

Accordingly, the present invention has been designed to address at least the problems and/or disadvantages discussed above and to provide at least the advantages described below. Therefore, an aspect of present invention is to provide an apparatus and method for transmitting data on contention based resources in a radio communication system.

In accordance with an aspect of present invention, a method for transmitting data on contention based resource in a radio communication system in provided. The method includes a BS broadcasting a definition of uplink contention based resource groups and a criterion for selecting a group, and the UE selecting an uplink contention based resource to transmit data according to the criterion for selecting a group.

In accordance with another aspect of present invention, a UE for transmitting data on contention based resource in a radio communication system is provided. The UE includes a de-multiplexing module for de-multiplexing received signals and obtaining a pilot and broadcast channel signals, wherein the broadcast channel signals are de-multiplexed to obtain a definition of uplink contention based resource groups and a criterion for selecting a group after decoding; a downlink channel quality measuring module for measuring downlink channel quality according to the pilot de-multiplexed by the de-multiplexing module; and a contention based resource data transmission control module for selecting a contention based resource to transmit data based on the definition of uplink contention based resource groups and the criterion for selecting a group de-multiplexed from the broadcast channel and downlink channel quality measured by the downlink channel quality measuring module.

In accordance with another aspect of present invention, a BS for transmitting data on contention based resource in a radio communication system is provided. The BS includes a broadcast information control module for generating a definition of uplink contention based resource groups and a criterion for selecting a group; and a transmitter for transmitting the definition of the uplink contention based resource groups and the criterion for selecting a group to a radio channel.

### BRIEF DESCRIPTION OF THE DRAWINGS

The above and other aspects, features, and advantages of the present invention will become more apparent from the following detailed description when taken in conjunction with the accompanying drawings in which:

FIG. 1 is a diagram illustrating a flexible fractional frequency reuse scheme;

FIG. 2 is a diagram illustrating a BS dividing an uplink contention based resource within a radio frame in time domain;

FIG. 3 a diagram illustrating a BS dividing an uplink contention based resource among radio frames in a time domain;

FIG. 4 is a diagram illustrating a BS dividing an uplink contention based resource in a frequency domain;

FIG. 5 is a diagram illustrating a transmitting side of an SC-FDMA in a frequency domain;

FIG. 6 is a diagram illustrating SC-FDMA frames;

FIG. 7 is a diagram illustrating a BS for dividing an uplink contention based resource in a time and frequency domain;

FIG. 8 is a diagram illustrating a transmitting device and receiving device in a UE;

FIG. 9 is a diagram illustrating signaling of a definition of an uplink contention based resource groups and criterion for selecting a group broadcast by a BS;

FIG. 10 is a diagram illustrating a process flowchart for a UE;

FIG. 11 illustrates an example for a hardware diagram of a transmitting device in a BS;

FIG. 12 is a diagram illustrating an example of a hardware diagram for a UE; and

FIG. 13 is a block diagram illustrating a BS for transmitting a broadcast channel.

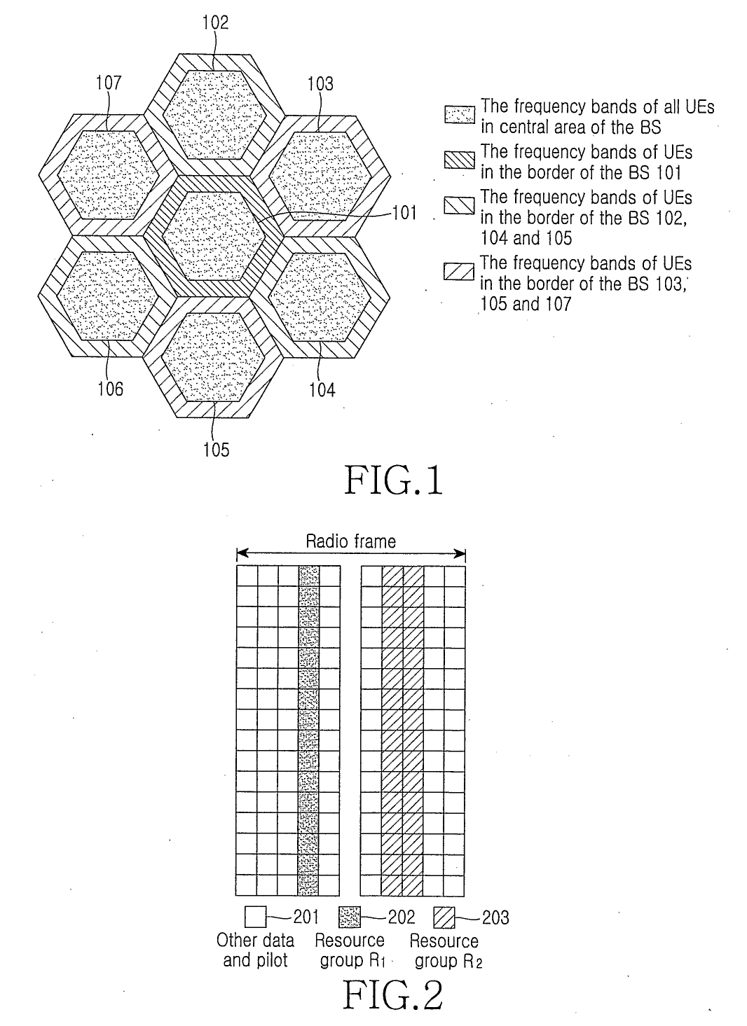

### DETAILED DESCRIPTION OF THE PREFERRED EMBODIMENTS

Preferred embodiments of the present invention will be described in detail herein below with reference to the accompanying drawings. Additionally, these preferred embodiments of the present invention will be disclosed merely for illustrative purposes. Accordingly, those skilled in the art will appreciate that various modifications, additions, and substitutions are possible, without departing from the scope of the present invention.

I. The BS Broadcasts the Definition of the Uplink Contention Based Resource Groups and Criterion for Selecting the Group.

The BS makes groups of the uplink contention based resources. The groups can be made in a time domain, in a frequency domain, or in both of time and frequency domains.

Grouping in a time domain, namely, the BS divides the contention based resource into groups of one or several SC-FDMA symbols, and every group is provided for UEs that satisfy a certain condition. This grouping falls into two categories. One is that all the groups are in a same radio frame, FIG. 2 is taken as an example.

Referring to FIG. 2, resource group R₁ 202 occupies one SC-FDMA symbol of the radio frame, while resource group R₂ 203 occupies another two SC-FDMA symbols of the same radio frame. Other data or pilots 201 occupy the remainder of the radio frame.

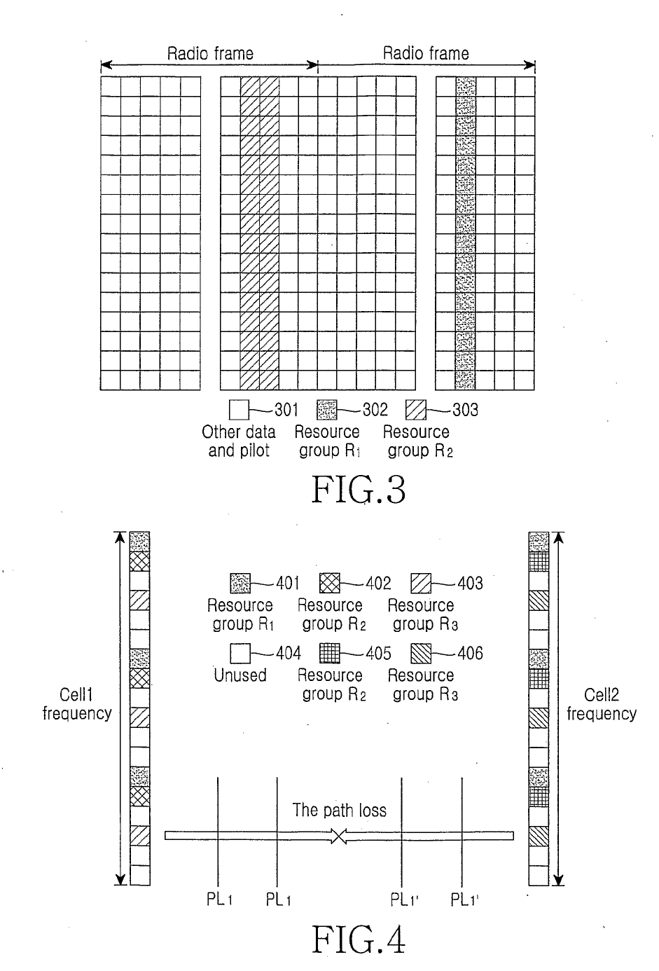

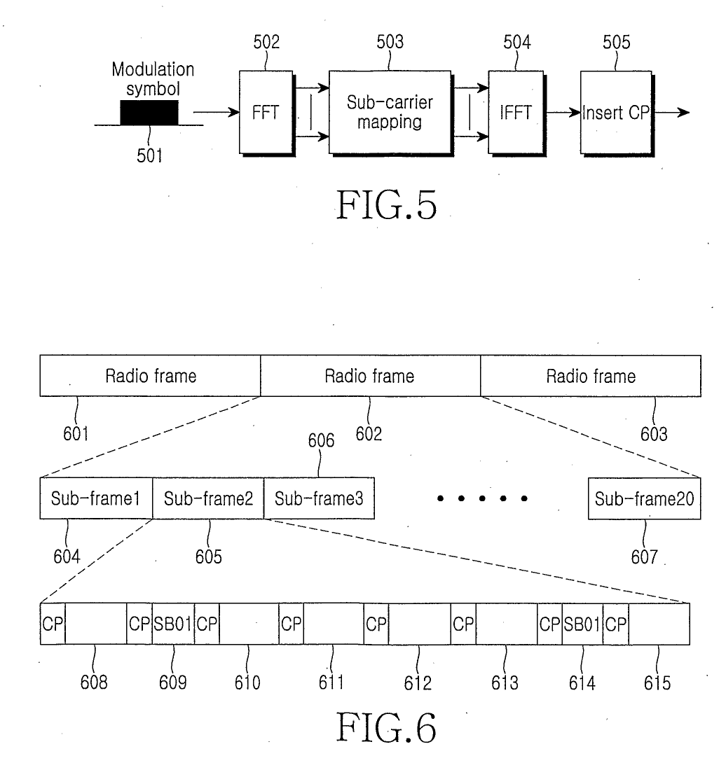

The second method is that the groups are in different radio frames. FIG. 3 is taken as an example of the second method.

Referring to FIG. 3, resource group R₁ 302 occupies one SC-FDMA symbol of the radio frame, while resource group R₂ 303 occupies two SC-FDMA symbols of another radio frames. Other data or pilots 301 occupy the remainder of the radio frame.

The grouping is in frequency domain, namely, the BS divides contention based resources into groups of several sub-carriers, every group being provided for UEs that satisfy a certain condition.

FIG. 4 is a diagram illustrating a BS dividing an uplink contention based resource in a frequency domain.

Referring to FIG. 4, in cell 1, the BS divides the contention based resource into 3 groups based on sub-carriers: resource group R₁ 401, resource group R₂ 402, and resource group R₃ 403. In cell 2, the BS also divides the contention based resource into 3 groups based on sub-carriers: resource group R₁ 401, resource group R₂′ 405, and resource group R₃′ 406. In this embodiment, the resource group R₁ 401 made in cell 1 and cell 2 contains the same sub-carrier; resource group R₂ 402 made in cell 1 and resource group R₂′ 405 made in cell 2 contain different sub-carriers, the frequency reuse factor is 2; and resource group R₃ 403 made in cell 1 and resource group R₃′ 406 made in cell 2 contain different sub-carriers, the frequency reuse factor is 3. cell 1 and cell 2 also include unused resources 404.

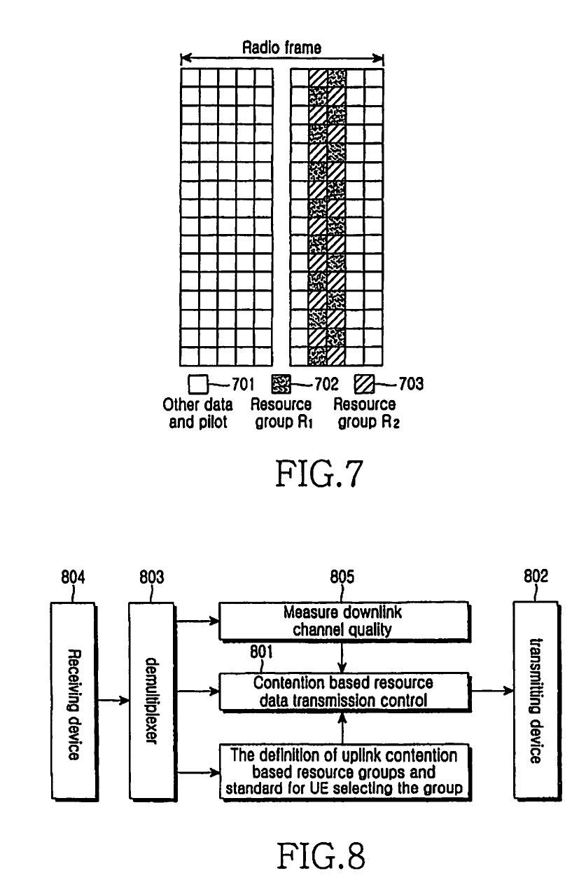

Grouping in both of time and frequency domain is that the BS divides the contention based resource into groups of several two dimension grids of time and frequency domain, and every group is provided for the UEs that satisfy a certain condition. FIG. 7 is taken as an example, wherein FIG. 7 is a diagram illustrating a BS for dividing an uplink contention based resource in a time and frequency domain.

Referring to FIG. 7, resource group R₁ 702 occupies several two dimensional grids of time and frequency resources in radio frame, while resource group R₂ 703 occupies several other two dimensional grids of time and frequency resources in the same radio frame. Further, the radio frame includes other data and pilots 701.

The BS needs to decide the criterion for selecting the group. Normally the UE select the criterion according to downlink channel quality measure report. The downlink channel quality measure report generally sets the path loss as the criterion. However, other channel quality measure reports can also be used, such as SNR of common pilot.

The BS sets the grouping criterion generally by setting a corresponding threshold. For example, if the path loss is set as the criterion, when the contention based resource is divided into N groups (R₁, R₂, . . . R_{N}), N−1 corresponding threshold values PL₁<PL₂< . . . <PL_{N-1} needs to be set. When the path loss measured by the UE is PL<PL₁, the UE selects resource group R₁. When the path loss measured by the UE is PL₁<PL<PL₂, the UE selects resource group R₂. When the path loss measured by the UE is PL₂<PL<PL₃, the UE selects resource group R₃, . . . When the path loss measured by the UE is PL>PL_{N-1}, the UE selects resource group R_{N}.

FIG. 4 is a diagram illustrating a BS dividing an uplink contention based resource in a frequency domain. Referring to FIG. 4, in cell 1 and cell 2, the contention based resource is divided into 3 groups respectively. Thresholds of cell 1 is PL₁ and PL₂, the thresholds of cell 2 is PL₁′ and PL₂′. The example illustrated in FIG. 4 applies flexible fractional frequency reuse principle: resource group R₁ 401 corresponds to relatively small path loss, thus the frequency reuse factor is 1; resource group R₂ 402 corresponds to relatively medium path loss, thus the frequency reuse factor is 2; resource group R₃ 403 corresponds to relatively large path loss, thus the frequency reuse factor is 3.

The BS needs to broadcast the above-described definition of uplink contention based resource groups and the criterion for the UE selecting the group. This can implemented by transmitting the information in a broadcast channel.

II. The UE Selects the Uplink Contention Based Resource to Transmit Data According to Criterion to Select the Group.

When the UE needs to transmit data on a contention based resource, the UE determines the required measure value based on the criterion to select the group. In general, the UE selects according to a downlink channel quality measure report. For example, when the path loss is used as the criterion for selecting the group, the UE measures the path loss correspondingly. In order to achieve a reliable measurement, the path loss generally has a long measuring time. The UE selects the uplink contention based resource to transmit data based on the measured value and criterion to select the group. For example when setting criterion to select the group using a threshold, when the contention based resource is divided into N groups (R₁, R₂, . . . R_{N}), there are N−1 corresponding thresholds PL₁<PL₂< . . . <PL_{N-1}. The UE selects a resource group according to the criterion.

Referring back to FIG. 4, for the UE in cell 1, when the measured path loss is PL<PL₁, the UE selects resource group R₁ 401, when the measured path loss is PL₁<PL<PL₂, the UE selects resource group R₂ 402, and when the measured path loss is PL>PL₂, the UE selects resource group R₃ 403. For the UE in cell 2, when the measured path loss is PL<PL₁′, the UE selects resource group R₁ 401, when the measured path loss is PL₁′<PL<PL₂′, the UE selects resource group R₂′ 405, and when the measured path loss is PL>PL₂′, the UE selects resource group R₃′ 406.

FIG. 8 is a diagram illustrating a transmitting device and receiving device in a UE. In the transmitting and receiving devices 802 and 804 of the UE illustrated in FIG. 8, a contention based resource data transmission control module 801 is included in the UE according to an embodiment of the present invention. The contention based resource data transmission control module 801 selects the corresponding uplink contention based resource to transmit data in transmitting device 802 based on the definition of the uplink contention based resource groups and the criterion for the UE selecting the group and downlink channel quality measurement broadcast from the BS. The de-multiplexing module 803 de-multiplexes signals in the receiving device 804 and retrieves a pilot and broadcast channel signals. Here, the broadcast channel signal may be further de-multiplexed to receive the definition of the uplink contention based resource groups and the criterion that the UE uses to select the group after decoding, which are output to the contention based resource data transmission control module 801. The downlink channel quality measuring module 805 measures downlink channel quality using the pilot de-multiplexed by 803 module and output to the contention based resource data transmission control module 801.

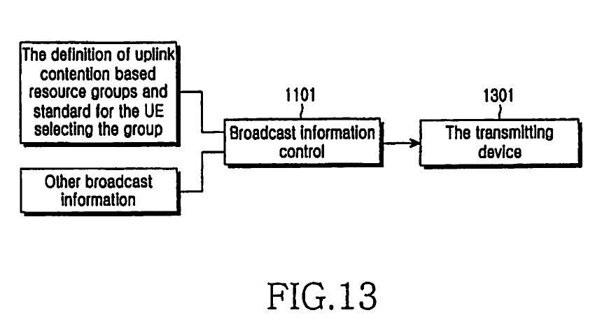

FIG. 13 is a block diagram illustrating a BS for transmitting a broadcast channel. In the block diagram for the BS transmitting broadcast channel illustrated in FIG. 13, the broadcast channel control module 1101 of the BS embodies present invention. The broadcast channel control module 1101 of the BS multiplexes a definition of uplink contention based resource groups, a criterion that the UE uses to select the group, and other broadcast information, and transmits data in transmitting device 1301. A detailed block diagram of the transmitting hardware in a BS will be described herein below in the Embodiments section.

### EMBODIMENTS

1) Operations of the BS

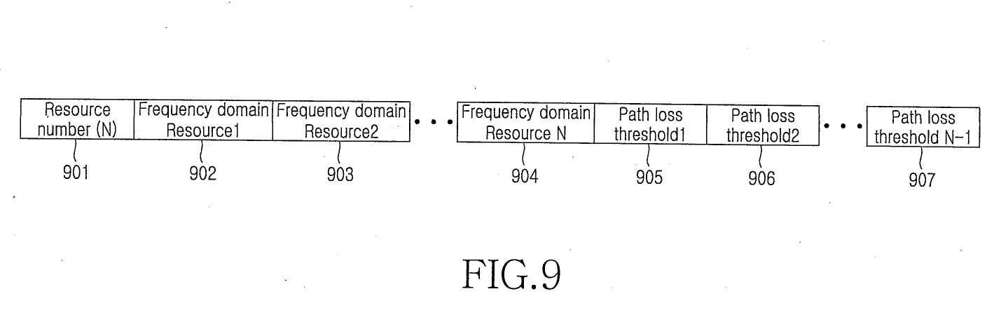

According to an embodiment of the present invention, the BS broadcasts the definition of the uplink contention based resource groups and the criterion that the UE uses to select the group. The uplink contention based resource is divided in a frequency domain, and the UE selects an uplink contention based resource based on path loss. An example of a signaling format in a broadcast channel is illustrated in FIG. 9.

Referring to FIG. 9, a number of the contention based resource group (N) 901 is transmitted first. Thereafter, the frequency domain resource information of N groups is transmitted as follows: frequency domain resource 1 902, frequency domain resource 2 903, . . . frequency domain resource N 904. Information of frequency domain resource is generally information of sub-carriers occupied by every group of resources. Finally, thresholds of N−1 path loss are transmitted in the following order: path loss threshold 1 905, path loss threshold 2 906 . . . and path loss threshold N−1 907.

2) The Operations of the UE

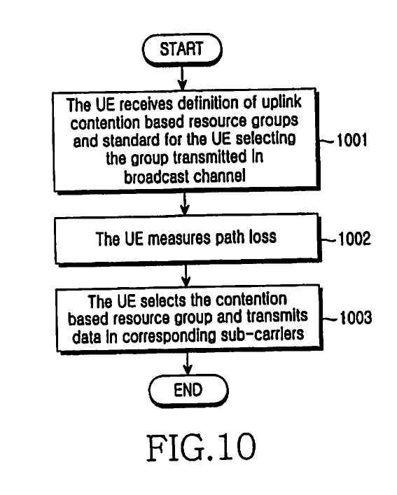

A flowchart of the UE operations according to an embodiment of the present invention is illustrated in FIG. 10.

Referring to FIG. 10, the UE receives the definition of the uplink contention based resource groups and the criterion for selecting the group transmitted in broadcast channel in step 1001. In step 1002, the UE measures the path loss. Generally, in order to perform radio resource management, the UE continuously measures path loss of its cell after accessing to the radio network, thus the UE does not execute this step after the uplink contention based resource transmission, but only acquires existing measure result of path loss. In step 1003, the UE selects the contention based resource group and transmits data in the corresponding sub-carriers. For example, the UE may use the specific selecting algorithm as described above.

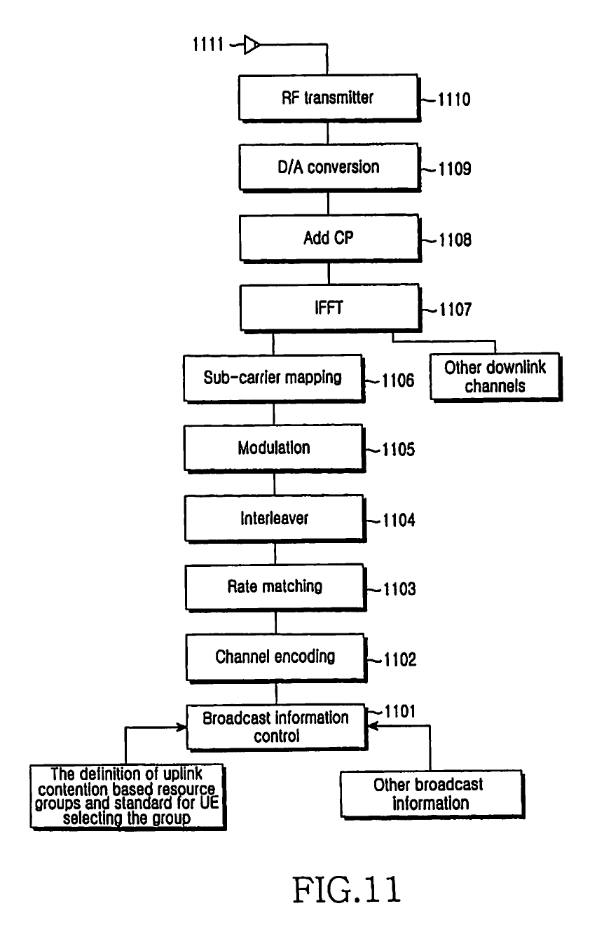

FIG. 11 illustrates an example for a hardware diagram of a transmitting device in a BS according to an embodiment of the present invention. In this embodiment, the BS downlink transmission applies Orthogonal Frequency Division Multiplex (OFDM).

Referring to FIG. 11, the BS multiplexes a definition of uplink contention based resource groups, information of a criterion that the UE uses to select the group, and other broadcast information in a broadcast information control module 1101, and then performs encoding in the channel coding module 1102. The encoded data is processed by the rate matching module 1103, and is interleaved in an interleaver 1104, which corrects performance loss caused by channel fading. Data processed by interleaver 1104 is modulated in a modulation module 1105, and then undergoes sub-carrier mapping in sub-carrier mapping module 1106. After mapping, frequency domain signals are multiplexed with other downlink channels and converted to time domain signals in IFFT module 1107. Thereafter, the signal is attached with a CP in CP module 1108 to prevent inter-sub-carrier interference. The signal is then converted from a digital signal into an analog signal by the A/D converter 1109. The analog signal is input into a Radio Frequency (RF) transmitter 1110 to experience RF related operations. Finally, the signal from the RF transmitter is transmitted to the radio channel through an antenna 1111.

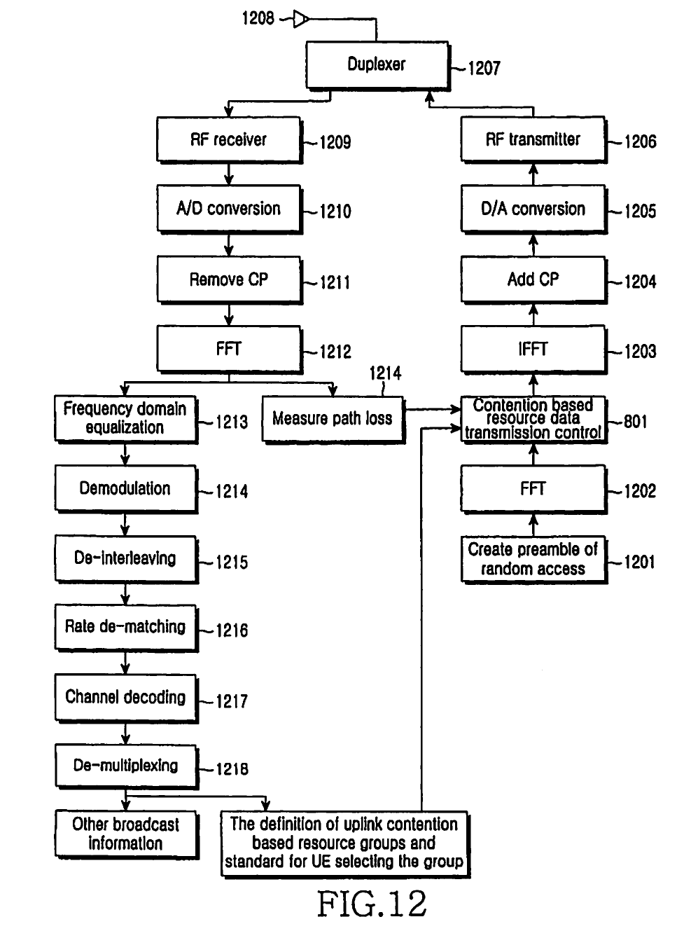

FIG. 12 is a diagram illustrating an example of a hardware diagram for a UE according to an embodiment of the present invention. In this embodiment, the UE downlink receiving uses OFDM, while the uplink transmission uses SC-FDMA. The UE transmits a preamble of the random access on the contention based resource.

Referring to FIG. 12, first a description of a hardware structure of a transmitting side of a UE will be given. the UE creates a random access preamble in a preamble module 1201. Generally, the UE selects one preamble randomly from an available preamble set and modulates.

The preamble is converted into frequency domain signals after the FFT operation by FFT module 1202. The contention based resource data transmission control module 801 selects the frequency domain resource to transmit preamble of random access based on the definition of the uplink contention based resource groups and the criterion used by the UE for selecting the group de-multiplexed from de-multiplexing module 1218 and path loss measured by path loss module 1214. Contention based resource data transmission control module 801 actually takes the effect of sub-carrier mapping.

The frequency domain signals are converted into time domain signals through IFFT operation in IFFT module 1203, a CP is added to prevent interference among symbols in CP module 1204, and digital signals are converted to analog signals in D/A converter 1205. The digital signal is input into the RF transmitter 1206 to experience RF related operations. The output from the RF transmitter is input into the duplexer 1207 and finally transmitted to the radio channel through antenna 1208.

Next, a description of a hardware structure of a receiving side of the UE will be given. The downlink signal transmitted by a BS is received by antenna 1208 and is input into an RF receiver 1209 through duplexer 1207. Here, an oscillator is regulated and operation of Automatic Gain Control (AGC) is performed on the signal. The received signal is converted from analog to digital in an Analog-to-Digital Converter (ADC) 1210. A CP of the digital signal is removed in CP module 1211, and converted from time domain signals into frequency domain signals through FFT operation in FFT module 1212.

The pilot de-multiplexed from frequency domain signal is used to measure path loss in path loss module 1214 and the measure result is sent to the contention based resource data transmission control module 801 to assist judgment.

Additionally, the broadcast channel signal de-multiplexed from frequency domain signal undergoes frequency domain equalization in frequency domain equalization module 1213 to correct effects on signals by radio channel. The signals are then demodulated in demodulation module 1214, de-interleaved in de-interleaving module 1215, de-rate matching in de-rate matching module 1216, and channel decoded in channel decoding module 1217 to restore the transmitted broadcast channel information. Finally, the signal is de-multiplexed in de-multiplexing module 1218, and the definition of the uplink contention based resource groups and the criterion that the will use UE to select the group is retrieved. The results are sent to the contention based resource data transmission control module 801 to assist operation.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A method for transmitting data on a contention based resource in a radio communication system, the method comprising:
broadcasting, by a Base Station (BS) a definition of uplink contention based resource groups and a criterion for a User Equipment (UE) to use for selecting a group; and
selecting, by the UE, an uplink contention based resource to transmit data according to the criterion for selecting the group.

2. The method according to claim 1, wherein the definition of the uplink contention based resource groups group the uplink contention based resources in a time domain.

3. The method according to claim 2, wherein the grouping in the time domain groups the resources in radio frames.

4. The method according to claim 2, wherein the grouping in the time domain groups in a radio frame.

5. The method according to claim 1, wherein the uplink contention based resource groups includes groups in a frequency domain.

6. The method according to claim 5, wherein the groups in the frequency domain are determined by dividing the contention based resource into groups of several sub-carriers.

7. The method according to claim 6, wherein a frequency reuse factor of a UE in a central area of a cell is 1, and a frequency reuse factor of UEs in a border area of the cell is greater than 1.

8. The method according to claim 1, wherein the uplink contention based resource groups includes groups in both of a time and frequency domain.

9. The method according to claim 7, wherein the groups in both of the time and frequency domain are determined by grouping the contention based resource into several two-dimension grids of the time and frequency domain.

10. The method according to claim 9, wherein a frequency reuse factor of a UE in a central area of a cell is 1, and a frequency reuse factor of a UE in a border area of the cell is greater than 1.

11. The method according to claim 1, wherein the criterion for the UE to use for selecting the group utilizes a downlink channel quality measure report.

12. The method according to claim 11, wherein the downlink channel quality measure report includes path loss.

13. The method according to claim 11, wherein the downlink channel quality measure report includes a Signal to Noise Ratio (SNR) of a common pilot.

14. The method according to claim 1, wherein the criterion for the UE to use for selecting the group includes several thresholds.

15. The method according to claim 14, wherein a format that the BS broadcasts the definition of the uplink contention based resource groups and the criterion for the UE to use for selecting the group includes resource group number (N), resource group definitions 1 through resource group definition N, and threshold 1 through threshold N−1, where N is an integer greater than 1.

16. The method according to claim 14, further comprising:
if the contention based resource is divided into N Resource (R) groups (R₁, R₂, . . . R_{N}) and the corresponding N−1 thresholds is Path Loss (PL)₁<PL₂< . . . <PL_{N-1}, then
when a measured value by the UE is PL<PL₁, the UE selects the resource group R₁;
when the measured value by the UE is PL₁<PL<PL₂, the UE selects the resource group R₂;
when the measured value by the UE is PL₂<PL<PL₃, the UE selects the resource group R₃; and
when the measured value by the UE is PL>PL_{N-1}, the UE selects the resource group R_{N}.

17. The method according to claim 1, further comprising:
transmitting, by the UE, a random access preamble in the selected uplink contention based resource.

18. The method according to claim 1, further comprising:
transmitting, by the UE, random access data in the selected uplink contention based resource.

19. The method according to claim 1, further comprising:
transmitting, by the UE, a scheduling request in the selected uplink contention based resource.

20. An apparatus for transmitting data on a contention based resource in a User Equipment (UE) of a radio communication system, the apparatus comprising:
a de-multiplexing module, for de-multiplexing received signals and obtaining a pilot and broadcast channel signals, wherein the broadcast channel signals are de-multiplexed to obtain a definition of uplink contention based resource groups and a criterion for selecting a group after decoding;
a downlink channel quality measuring module for measuring downlink channel quality according to the pilot de-multiplexed by the de-multiplexing module;
a contention based resource data transmission control module for selecting a contention based resource to transmit data based on the definition of the uplink contention based resource groups and the criterion for selecting the group de-multiplexed from the broadcast channel, and the downlink channel quality measured by the downlink channel quality measuring module.

21. An apparatus for transmitting data on a contention based resource in Base Station of a radio communication system, the apparatus comprising:
a broadcast information control module for generating a definition of uplink contention based resource groups and a criterion for selecting a group; and
a transmitter for transmitting the definition of the uplink contention based resource groups and the criterion for selecting the group to a radio channel.
